(19) United States
(12) Patent Application Publication
(10) Pub. No.: US 2005/0009404 A1
(43) Pub. Date: Jan. 13, 2005

(54) USB adapter with a power connector

(76) Inventor: Andrew Lee, Fremont, CA (US)

Correspondence Address: DELLETT AND WALTERS, P. O. BOX 2786, PORTLAND, OR, 97208-2786, US

(21) Appl. No.: 10/616,115

(22) Filed: Jul. 7, 2003

(51) Int. Cl. H01R 25/00

(52) U.S. Cl. 439/638

(57) ABSTRACT

A USB adapter with a power connector has a USB adapter and two power wires. The USB adapter has a proximal end, a distal end, four wires, a USB connector formed on the proximal end and a USB socket formed on the distal end. The two of the four wires are power and ground wires and the other two wires are data wires. The two power wires have proximal ends and distal ends, and the proximal ends are electrically connected respectively to the two wires that are power and ground wires in the USB adapter. The distal ends of the two power wires connect to a power connector. The USB adapter with a power connector uses two power wires to supply power to an external device that needs power but does not transfer data so the USB adapter with a power connector is cost-effective.

### BACKGROUND OF THE INVENTION

1. Field of the Invention

The present invention relates to an USB adapter with a power connector, and more particularly to an USB adapter with a power connector that can supply power without transferring data to an external device that only needs power.

2. Description of Related Art

Progression in the electronics industry has resulted in the invention of more and more external devices for computers. An external device needs to connect to a computer to work. To achieve it, a computer needs a socket to connect to an external device, while an external device would need a connector to plug into the computer. The socket and the connector must mate so they can work together. The call for a standardized connection between computers and external devices has resulted the invention of the USB (Universal Serial Bus). The Universal Serial Bus (USB) socket/connector has become a standard in the computer industry for some years now. The USB socket/connector gives us a single, standardized, easy-to-use way to connect to an external device.

With reference to FIGS. 4 and 5, there are two types of USB connectors—type A USB connector (40) and type B USB connector (50). A traditional USB connector will have to either Type A or Type B. The type A USB connector (40) has an inner recess (not numbered) and four pins (not numbered) in the inner recess. The four pins in the type A USB connector (40) are parallel with each other. The type B USB connector (50) may have many configurations and has multiple pins (not numbered) arranged in parallel or in two rows. A common type B USB connector (50) has eight pins (not numbered) arranged in two rows. A type A USB connector (40) connects to a type A USB socket (not shown) and a Type B USB Connector (50) connects to type B USB socket (not shown) respectively.

In general, a computer or a notebook computer has a limited number of USB sockets. Various external devices such as a mouse, keyboard, printer, scanner, digital camera, CD-ROM player, MPEG player, reading light or a personal fan can be connected to a computer or a notebook computer. Each device has a USB connector to plug into a USB socket on the computer or notebook computer. When the number of USB sockets on a computer or on a notebook computer is not enough, a USB hub may be plugged into the computer or notebook computer to extend the number of external devices connected to the computer.

With reference to FIG. 6, a conventional USB hub has two ends, a USB connector (not shown) attached to one end and multiple USB sockets (10) attached to the other end. The USB connector on the USB hub can plug into any USB socket on the computer, notebook computer or external device. Multiple USB sockets (10) can allow a user to plug in a USB connector (12) from an external device and transfer data through the USB socket (10) to the computer.

The external device plugged into the USB socket (10) can obtain power from the host via the USB socket (10) and does not have to connect to an external power supply or use any additional power cables. Since the USB connector has become a standard, USB sockets (10) can be found on every computer, and non-computer related USB powered devices have started to evolve and be seen in the market especially for notebook computer users. Almost any 5 volt DC power driven device can be powered by a USB socket (10). An example of a non-computer related USB powered device can be a reading light, fan, coffee-warmer, notebook cooler or even an electric tooth brush. The non-computer related USB powered device generally utilizes the USB socket (10) just to obtain power from a host computer and the USB connector (12) on the device does not have data wires.

A conventional type A USB socket (10) has four pins connected to four wires of which two are power and ground wires, and two are data wires. While a USB hub has multiple USB socket (10) such as the one with four USB sockets (10) on it needs a built-in control circuitry to control the data transferring back and forth between the host computer and the external devices. A built-in control circuitry usually consists of a chipset and various components such as resistors, transistors and capacitors. A conventional hub like this with built-in control circuitry is expensive compared to the related invention. The control chipset and the components for transferring data are unnecessary if the external device just draws power from the host computer.

Therefore, the invention provides a USB adapter with a power connector to mitigate or obviate the aforementioned problems.

### SUMMARY OF THE INVENTION

The main objective of the present invention is to provide a cost-effective USB adapter with a power connector to supply power to an external device that draws power but does not transfer data.

To achieve the objective, a USB adapter with a power connector in accordance with the present invention comprises a USB adapter and two power wires. The USB adapter has two ends, four wires, a USB connector formed on one end and a USB socket formed on the other end. Two of the four wires are power and ground wires and the other two are data wires. The two power wires have two ends, and one end is electrically connected to the two wires that are power and ground wires in the USB adapter. The other end of the two power wires can connect to a power connector. The USB adapter with a power connector uses two power wires to supply power to an external device that draws power but does not transfer data so the USB adapter with a power connector is cost-effective.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a first embodiment of a USB adapter with a power connector in accordance with the present invention;

FIG. 2 is a top plane view of the USB adapter with a power connector in FIG. 1;

FIG. 3 is perspective view of a second embodiment of a USB adapter with a power connector in accordance with the present invention;

FIG. 4 is a side plane view of a conventional type A USB connector in accordance with the prior art;

FIG. 5 is a side plane view of a conventional type B USB connector in accordance with the prior art; and

FIG. 6 is a perspective view of a conventional USB hub and four USB connectors in accordance with the prior art.

### DETAILED DESCRIPTION OF THE INVENTION

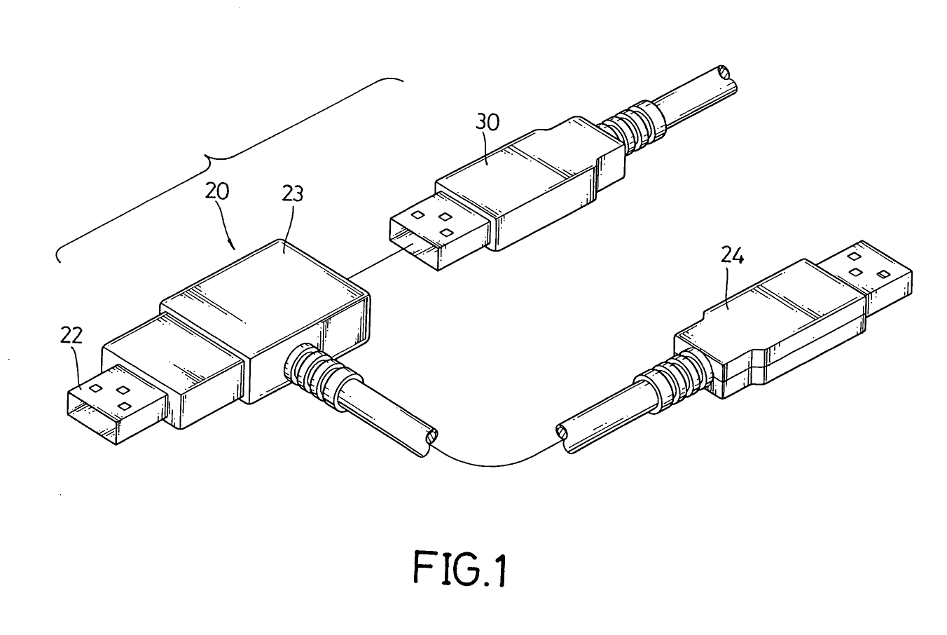

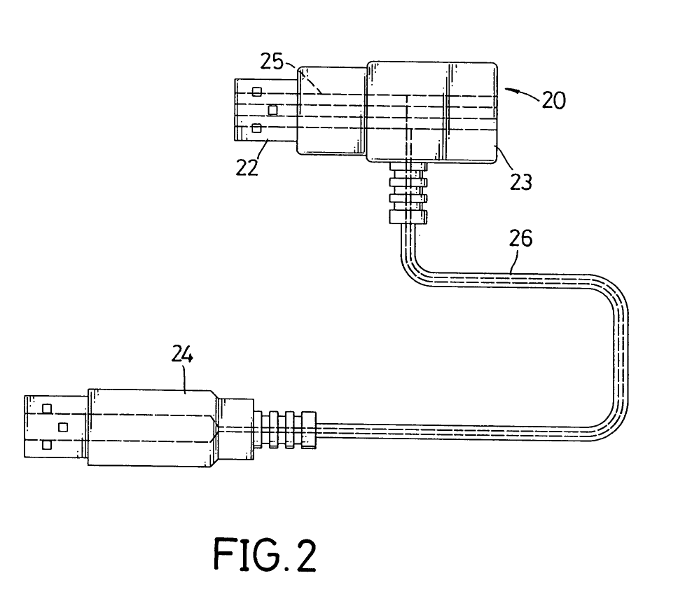

With reference to FIGS. 1 and 2, a first embodiment of a USB adapter with a power connector in accordance with the present invention comprises a USB adapter (20) and two power wires (26). The USB adapter (20) has a proximal end (not numbered), a distal end (not numbered), four wires (25), a USB connector (22) and a USB socket (23). The USB connector (22) is formed on the proximal end of the USB adapter (20), and the USB socket (23) is formed on the distal end. The USB connector (22) on the USB adapter (20) can be a type A USB connector and plug into a USB socket (not shown) on a host computer or notebook computer. The USB socket (23) on the USB adapter (20) can be a type A USB socket and can be plugged into a USB connector (30) on an external device. The two of the four wires (25) are power and ground wires (not numbered) and the other two of the four wires (25) are data wires (not numbered).

Each of the two power wires (26) has a proximal end (not numbered) and a distal end (not numbered), and the proximal ends are electrically connected respectively to the wires (25) that are power and ground wires of the USB adapter (20). The distal ends of the power wires (26) can directly connect to an external device that draws power but does not transfer data or connect to a power connector (24). The power connector (24) can be any kind of connector including a USB connector. Preferably, the power connector (24) is a type A USB connector. The power connector (24) can connect to an external device that needs power but does not transfer data.

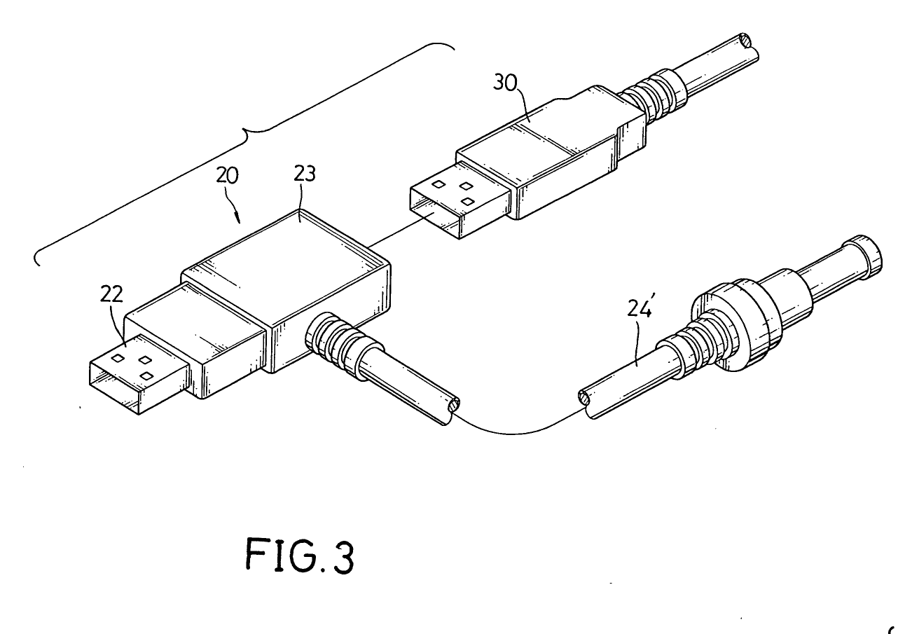

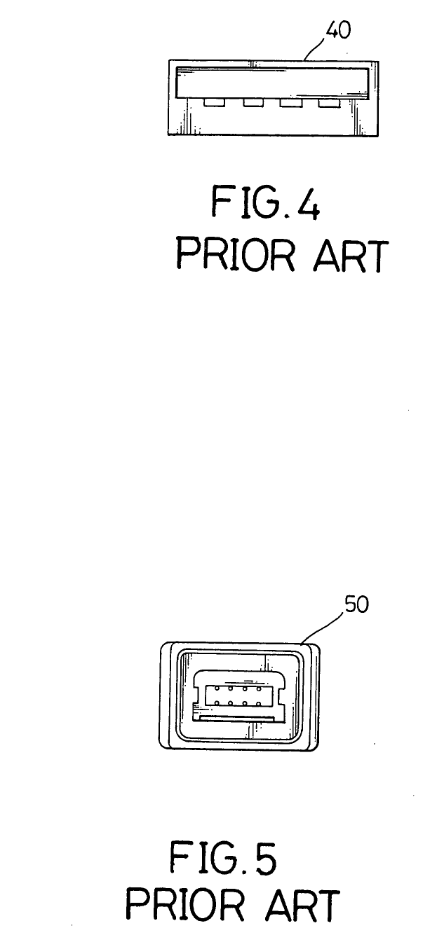

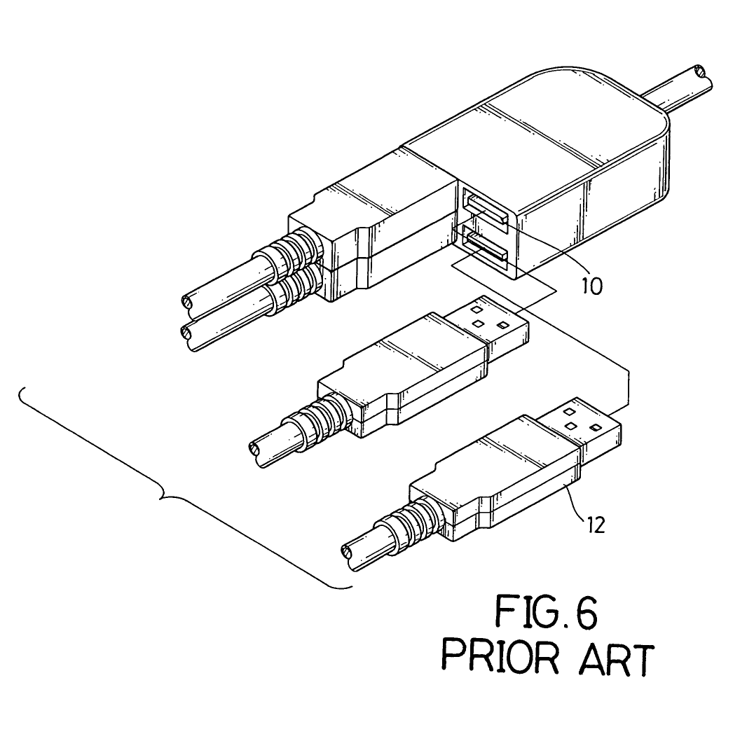

With reference to FIG. 3, a second embodiment of a USB adapter with a power connector in accordance with the present invention has a power connector (24′) different from the first embodiment. The power connector (24′) is a standard DC power connector that can connect to an AC to DC power adapter.

The present invention is a good substitute for a USB hub to power devices that do not transfer data. Multiple non-computer related USB powered devices include USB powered lights, fans, coffee-warmers, notebook coolers and so on. The non-computer related USB powered devices that draws 5 volt DC power can be powered via a USB socket by the host computer and utilize the USB socket just to obtain power. The USB adapter with a power connector in accordance with the present invention only has power wires to supply power and economize on wires that transfer data. The present invention is cost-effective.

Although the invention has been explained in relation to its preferred embodiment, it is to be understood that many other possible modifications and variations can be made without departing from the spirit and scope of the invention as hereinafter claimed.

1. A USB adapter with a power connector comprising:
a USB adapter having a proximal end, a distal end, four wires, an USB connector formed on the proximal end and a USB socket formed in the distal end, wherein the two wires of the four wires are power and ground wires and the other two wires of the four wires are data wires; and
two power wires having proximal ends and distal ends, and the proximal ends are electrically connected respectively to the two wires that are power and ground wires in the USB adapter.

2. The USB adapter with a power connector as claimed in claim 1, wherein the distal ends of the power wires are connected to a power connector.

3. The USB adapter with a power connector as claimed in claim 2, wherein the power connector is a USB connector.

4. The USB adapter with a power connector as claimed in claim 2, wherein the power connector is a standard DC power connector.
